(19) United States
(12) Patent Application Publication
(10) Pub. No.: US 2012/0233376 A1
(43) Pub. Date: Sep. 13, 2012

(54) CONTROL DEVICE FOR STORAGE

(75) Inventor: Toshihisa ANBAI, Kawasaki (JP)

(73) Assignee: FUJITSU LIMITED, Kawasaki (JP)

(21) Appl. No.: 13/357,239

(22) Filed: Jan. 24, 2012

(30) Foreign Application Priority Data
Mar. 9, 2011 (JP) 2011-052243

(51) Int. Cl. G06F 13/00

(52) U.S. Cl. 710/316

(57) ABSTRACT

A control device for controlling a storage device in which data is stored, the control device includes a processor that sets protection condition of the storage device through a signal line coupled with the storage device and sets the protection condition of the storage device through a first transmission line coupled with the control device, and an exchange switch coupled with the control device and an arithmetic operation device through the first transmission line and a second transmission line, respectively, the exchange switch being configured to switch between the first transmission line and the second transmission line so as to communicably couple either one of the control device and the arithmetic operation device with the storage device.

### CROSS-REFERENCE TO RELATED APPLICATION

This application is based upon and claims the benefit of priority of the prior Japanese Patent Application No. 2011-052243, filed on Mar. 9, 2011, the entire contents of which are incorporated herein by reference.

### FIELD

The embodiments discussed herein are related to a control device which controls a storage device.

### BACKGROUND

An ordinary data processing device has a non-volatile memory including a flash memory for storing a program group, e.g., a BIOS (Basic Input/Output System) which controls a peripheral and provides an OS (Operating System) with a process to input and output data to and from the peripheral.

FIG. 1 illustrates an exemplary constitution of a data processing device 100 having a flash memory. The data processing device 100 illustrated in FIG. 1 has a CPU (Central Processing Unit) 110, a controller 120, a bus exchange switch 130 and a flash memory 140.

The CPU 110 is coupled with the flash memory 140 in terms of signals through the bus exchange switch 130, and so is the controller 120. The bus exchange switch 130 may switch between a regular use route for coupling the CPU 110 with the flash memory 140 in terms of signals and a control route for coupling the controller 120 with the flash memory 140 in terms of signals.

Further, the flash memory 140 has a control memory (including a control register) 141 as an interface for controlling the flash memory 140. The controller 120 operates the control memory 141 so as to control write-protection for the flash memory 140 or write-protection for the control memory 141.

In order to set the write-protection for the flash memory 140, e.g., the controller 120 operates the bus exchange switch 130 in a specific way so as to switch the regular use route to the control route. Then, the controller 120 gives a value 1 to a write-protection bit of the control memory 141 that the flash memory 140 has. Data in the flash memory 140 is thereby write-protected.

Further, if a CRWP (Control Register Write Protect) bit of the control memory 141 is given “1” and a terminal /WP (Write Protect) is provided with a signal “0”, data in the control memory 141 is write-protected. The control memory 141 or the CPU 110 provides the terminal /WP of the flash memory 140 with a signal by using a signal line included in the control route or a signal line included in the regular use route.

Operate the bus exchange switch 130 in a specific way by means of the controller 120 after finishing the setting for the flash memory 140 so as to switch the control route to the regular use route, and then power on a system power source which drives the CPU 110. Then, the CPU 110 reads the BIOS and so forth from the flash memory 140 and runs what is read. Then, if input/output processes to and from peripherals are enabled, the CPU 110 reads the OS and so forth from a storage device and runs what is read.

FIG. 2 illustrates a state transition of the control memory 141 depending upon a combination of the signal provided to the terminal /WP of the flash memory 140 and the setting for the CRWP bit of the control memory 141. The control memory 141 is in a write-protected state only when a signal “0” is provided to the terminal /WP and “1” is set to the CRWP bit of the control memory 141 as illustrated in FIG. 2.

A flash memory known as a related art has a manually operated switch movable between a first position where a user may write data into a flash memory 4 and a second position where data keeps from being written into the flash memory 4.

A related art is disclosed, e.g., in Japanese National Publication of International Patent Application No. 2003-524842. If, e.g., the CPU 110 is powered on in the data processing device 100 illustrated in FIG. 1, the CPU 110 and so forth may generate noise in some cases. In this case, the noise is propagated to the flash memory 140 through the bus exchange switch 130.

If the noise causes the signal provided to the terminal /WP to switch over from “0” to “1”, the write-protection having been set for the control memory 141 is cancelled as illustrated in FIG. 3. In this case, data in the control memory 141 may be rewritten depending upon a noise pattern resulting in that the write-protection having been set for the flash memory 140 is cancelled as well. If the noise continues to flow into the flash memory 140 in that condition, the noise may cause data stored in the flash memory 140 to be broken or may cause the flash memory 140 to work wrong.

### SUMMARY

According to an aspect of the invention, an apparatus includes a control device for controlling a storage device in which data is stored, the control device includes a first setter that sets protection condition of the storage device through a signal line coupled with the storage device, a second setter that sets the protection condition of the storage device through a first transmission line coupled with the control device, and a exchange switch coupled with the control device and an arithmetic operation device through the first transmission line and a second transmission line, respectively, the exchange switch being configured to switch between the first transmission line and the second transmission line so as to communicably couple either one of the control device and the arithmetic operation device with the storage device.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 illustrates an exemplary constitution of a data processing device having a flash memory.

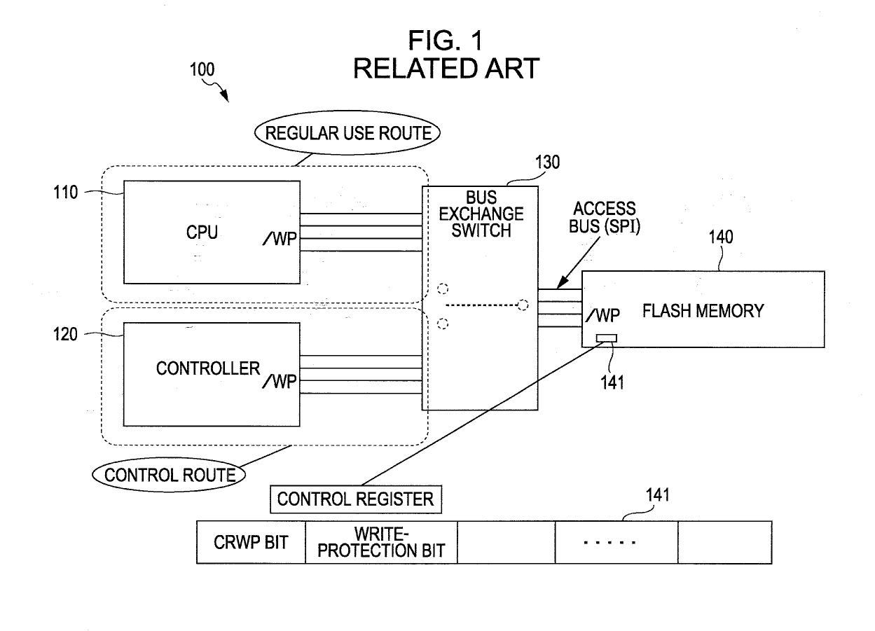

FIG. 2 illustrates a state transition of the control memory depending upon a combination of the signal provided to the terminal /WP of the flash memory and the setting for the CRWP bit of the control memory.

FIG. 3 illustrates a state in the controller in case of an occurrence of noise.

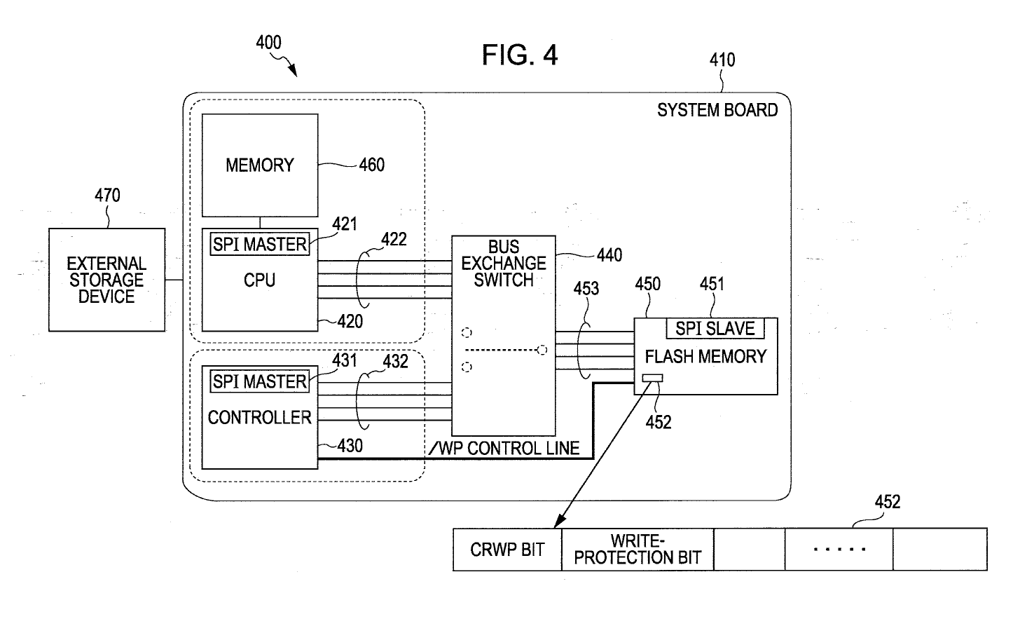

FIG. 4 illustrates an exemplary constitution of a system board to be mounted on a data processing device of the embodiment.

FIG. 5 illustrates an SPI master and an SPI slave to be used for the embodiment.

FIG. 6 specifically illustrates an exemplary main portion of the system board illustrated in FIG. 4.

FIG. 7 specifically illustrates an exemplary table to be used for the embodiment.

FIG. 8 illustrates an exemplary method for data processing used by a controller of the embodiment.

FIG. 9 illustrates a modification of the system board illustrated in FIG. 6.

FIG. 10 illustrates another modification of the system board illustrated in FIG. 4.

FIG. 11 specifically illustrates an exemplary main portion of a system board illustrated in FIG. 10.

FIG. 12 illustrates an exemplary process run by the system board illustrated in FIG. 11.

FIGS. 13A and 13B specifically illustrate a method for data processing run by a CPU and a controller as illustrated in FIG. 12.

FIG. 14 illustrates a relationship among devices in the process illustrated in FIGS. 13A and 13B.

### DESCRIPTION OF EMBODIMENTS

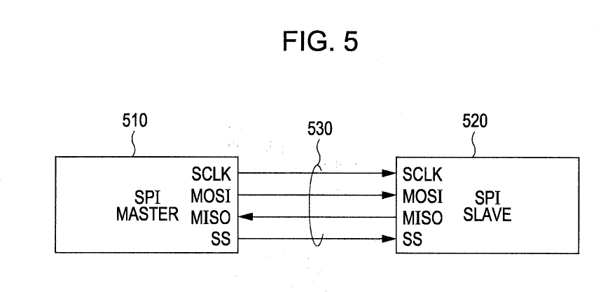

Hereinafter, an example of the embodiment will be explained on the basis of FIGS. 4 to 14. Incidentally, the embodiment explained below is exemplary only, and is not intended to exclude various modifications or technologies which will not be explicitly described below. That is, the embodiment may be variously modified and implemented within its scope.

FIG. 4 illustrates an exemplary constitution of a system board 410 to be mounted on a data processing device 400 of the embodiment.

The system board 410 has a CPU (processor) 420, a controller 430, a bus exchange switch 440, a flash memory 450 and a memory 460.

The CPU 420 is an arithmetic operation device which runs a specific arithmetic operation and so forth as instructed by a program read from the flash memory 450, an external storage device 470, etc. The CPU 420 has an SPI master 421 to be used for data communication carried out with the flash memory 450 by the use of an SPI (Serial Peripheral Interface). Incidentally, the SPI master 421 is coupled with an SPI bus 422 in terms of signals, which is omitted to be illustrated in FIG. 4 though.

The controller 430 is an arithmetic operation device which operates the bus exchange switch 440 and the flash memory 450 as instructed by a specific program or a circuit. Further, the controller 430 may be constituted by including one or a plurality of FPGAs (Field-Programmable Gate Arrays) for another embodiment. If so constituted, the FPGAs may be programmed to carry out data processing according to given logic as an arithmetic operation device does. The FPGA also calls a configurable logic circuit. The controller 430 has an SPI master 431 to be used for data communication carried out with the flash memory 450 by the use of an SPI. Incidentally, the SPI master 431 is coupled with an SPI bus 432 in terms of signals, which is omitted to be illustrated in FIG. 4 though.

Further, the controller 430 is directly coupled with a terminal /WP of the flash memory 450 through a /WP control line. A data transfer rate on the SPI bus is higher than that on the /WP control line.

The bus exchange switch 440 is coupled with the CPU 420 in terms of signals through the SPI bus 422. Further, the bus exchange switch 440 is coupled with the controller 430 in terms of signals through the SPI bus 432. Further, the bus exchange switch 440 is coupled with the flash memory 450 in terms of signals through an SPI bus 453.

The bus exchange switch 440 switches between a regular use route which couples the CPU 420 with the flash memory 450 in terms of signals and a control route which couples the controller 430 and the flash memory 450 in terms of signals as instructed by the controller 430.

The flash memory 450 is a storage device including a non-volatile memory in which data is stored. The flash memory 450 may store therein data including a BIOS. Further, the flash memory 450 has an SPI slave 451 to be used for data communication carried out with the CPU 420 and the controller 430 by the use of the SPI. Incidentally, the SPI slave 451 is coupled with the SPI bus 453 in terms of signals, which is omitted to be illustrated in FIG. 4 though.

Further, the flash memory 450 has the terminal /WP and a control memory (including a control register) 452 as interfaces to control the flash memory 450 from the outside. The control memory 452 includes a CRWP bit and a write-protection bit as illustrated in FIG. 4.

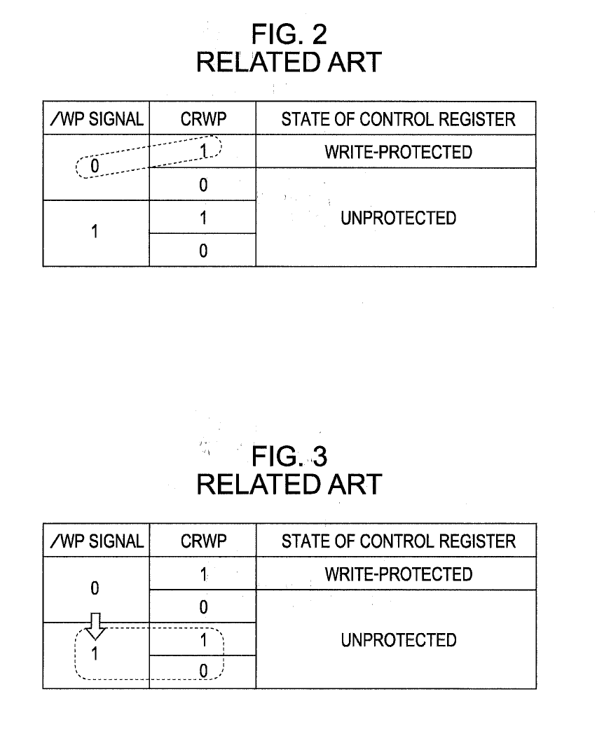

The controller 430 may control the state in the flash memory 450 by using a signal provided to the terminal /WP and a setting for the control memory 452. The flash memory 450 changes the state, e.g., in accordance with a combination of the signal provided to the terminal /WP and the setting for the control memory 452 illustrated in FIG. 2.

The CRWP bit is to write-protect data in the control memory 452. If “1” is set to the CRWP bit and the signal provided to the terminal /WP is “0”, the flash memory 450 write-protects data in the control memory 452.

The write-protection bit is to write-protect data in the flash memory 450. If “1” is set to the write-protection bit, the flash memory 450 write-protects data in the flash memory 450.

The controller 430 carries out data processing, i.e., writing data including the BIOS into the flash memory 450 or updating the data. Further, as starting to work at the same time as the data processing device 400 is powered on with the main power source, the controller 430 may set the flash memory 450 and the control memory 452 into write-protected states at that time.

After setting the flash memory 450 and the control memory 452 into the write-protected states, the controller 430 may switch from a control route access bus to a regular access bus. In this case, the flash memory 450 may be made read-only as viewed from the CPU 420.

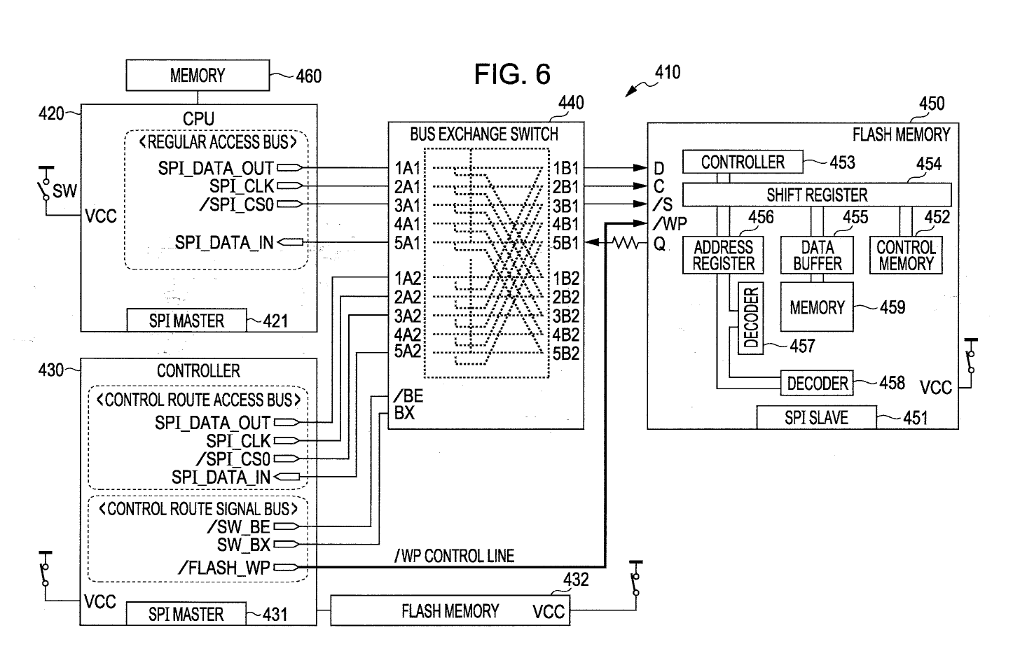

FIG. 5 illustrates an SPI master and an SPI slave to be used for the embodiment.

The SPI master 510 is coupled with the SPI slave 520 in terms of signals through an SPI bus 530.

The SPI master 510 has terminals SCLK, MOSI, MISO and SS. The terminal SCLK is to couple a signal line in terms of signals for transmitting a clock signal to the SPI slave 520. The terminal MOSI is to couple a signal line in terms of signals for transmitting data to the SPI slave 520. The terminal MISO is to couple a signal line in terms of signals for receiving data from the SPI slave 520. The terminal SS is to couple a signal line for choosing the SPI slave 520.

The SPI slave 520 has terminals SCLK, MOSI, MOSO and SS, as well. The terminal SCLK is to couple the signal line in terms of signals for receiving the clock signal from the SPI master 510. The terminal MOSI is to couple the signal line in terms of signals for receiving'data from the SPI master 510. The terminal MISO is to couple the signal line in terms of signals for transmitting data to the SPI master 510. The terminal SS is to couple a signal line for allowing the SPI master 510 to choose the SPI slave 520.

Incidentally, data communication between the SPI devices illustrated in FIG. 5, i.e., the SPI master 510 and the SPI slave 520 is done according to a known technology and its detailed explanation is omitted.

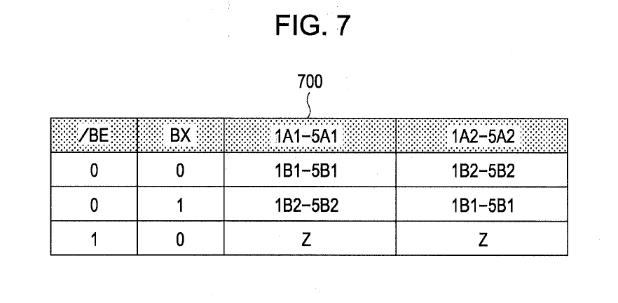

FIG. 6 specifically illustrates an exemplary main portion of the system board 410 illustrated in FIG. 4.

The SPI master 421 that the CPU 420 has is coupled with the bus exchange switch 440 in terms of signals through signal lines SPI_DATA_OUT, SPI_CLK, /SPI_CSO and SPI_DATA_IN. The CPU 420 operates the SPI master 421 so as to carry out communication by using the SPI.

Incidentally, the connective signal lines SPI_DATA_OUT, SPI_CLK, /SPI_CSO and SPI_DATA_IN are coupled with the terminals MOSI, SCLK, SS and MISO of the SPI master 421 in terms of signals, respectively, which is omitted to be illustrated in FIG. 6 though so that coupling relations in terms of signals among the main portions may be understood first.

The system power source drives the CPU 420. Turn a switch SW connected to a main power source of the data processing device 400 from off to on so that the CPU 420 is powered on with the system power source.

The SPI master 431 that the controller 430 has is coupled with the bus exchange switch 440 in terms of signals through signal lines SPI_DATA_OUT, SPI_CLK, /SPI_CSO and SPI_DATA_IN.

Further, the controller 430 is coupled with the bus exchange switch 440 in terms of signals through signal lines /SW_BE and SW_BX. The signal lines /SW_BE and SW_BX are coupled with terminals /BE and BX of the bus exchange switch 440 in terms of signals, respectively. The controller 430 may operate the bus exchange switch 440 by means of signals provided to the terminals /BE and BX as described later.

Further, the controller 430 is coupled with the flash memory 450 in terms of signals through a signal line /FLASH_WP. The signal line /FLASH_WP is coupled with a terminal /WP of the flash memory 450 in terms of signals. The controller 430 may operate a state in the flash memory 450, e.g., whether the control memory 452 or a memory 459 is set or reset as to write-protection by means of a signal provided to the terminal /WP of the flash memory 450 and a setting for the control memory 452.

Incidentally, the signal lines SPI_DATA_OUT, SPI_CLK, /SPI_CSO and SPI_DATA_IN are coupled with the terminals MOSI, SCLK, SS and MISO of the SPI master 431 in terms of signals, respectively, which is omitted to be illustrated in FIG. 6 though so that coupling relations in terms of signals among the main portions may be understood first.

The main power source of the data processing device 400 drives the controller 430. If, e.g., the data processing device 400 is powered on with the main power source, the controller 430 reads a specific program from the flash memory 432. Then, the controller starts data processing as instructed by the program having been read. Further, the controller 430 may be constituted by including one or a plurality of FPGAs (Field-Programmable Gate Arrays) for another embodiment. If so constituted, the FPGAs may be programmed to carry out data processing according to given logic as an arithmetic operation device does. The main power source of the data processing device 400 drives the flash memory 432, the bus exchange switch 440 and the flash memory 450, similarly as the controller 430.

The bus exchange switch 440 has terminals 1A1, 2A1, 3A1, 4A1 and 5A1. The terminals 1A1, 2A1, 3A1 and 5A1 are coupled with the signal lines SPI_DATA_OUT, SPI_CLK, /SPI_CSO and SPI_DATA_IN coming from the SPI master 421 that the CPU 420 has in terms of signals, respectively.

Further, the bus exchange switch 440 has terminals 1A2, 2A2, 3A2, 4A2 and 5A2. The terminals 1A2, 2A2, 3A2 and 5A2 are coupled with the signal lines SPI_DATA_OUT, SPI_CLK, /SPI_CSO and SPI_DATA_IN coming from the SPI master 431 that the controller 430 has in terms of signals, respectively.

Further, the bus exchange switch 440 has terminals 1B1, 2B1, 3B1, 4B1 and 5B1 and terminals 1B2, 2B2, 3B2, 4B2 and 5B2. The terminals 1B1, 2B1, 3B1 and 5B1 are coupled with terminals D, C, /S and Q that the flash memory 450 has in terms of signals, respectively. The terminals 1B2, 2B2, 3B2, 4B2 and 5B2 which will not be used for the embodiment are omitted to be explained.

The bus exchange switch 440 may couple the terminals 1A1-5A1 and the terminals 1B1-5B1, i.e., the terminals 1A1 and 1B1, 2A1 and 2B1, 3A1 and 3B1, 4A1 and 4B1, and 5A1 and 5B1 in terms of signals. Further, the bus exchange switch 440 may couple the terminals 1A1-5A1 and the terminals 1B2-5B2, i.e., the terminals 1A1 and 1B2, 2A1 and 2B2, 3A1 and 3B2, 4A1 and 4B2, and 5A1 and 5B2 in terms of signals.

Then, the bus exchange switch 440 switches between a state in which the terminals 1A1-5A1 are coupled with the terminals 1B1-5B1 in terms of signals and a state in which the terminals 1A1-5A1 are coupled with the terminals 1B2-5B2 in terms of signals depending upon signals inputted to the terminals /BE and BX.

The bus exchange switch 440 may similarly couple the terminals 1A2-5A2 and the terminals 1B1-5B1, i.e., the terminals 1A2 and 1B1, 2A2 and 2B1, 3A2 and 3B1, 4A2 and 4B1, and 5A2 and 5B1 in terms of signals. Further, the bus exchange switch 440 may couple the terminals 1A2-5A2 and the terminals 1B2-5B2, i.e., the terminals 1A2 and 1B2, 2A2 and 2B2, 3A2 and 3B2, 4A2 and 4B2, and 5A2 and 5B2 in terms of signals.

Then, the bus exchange switch 440 switches between a state in which the terminals 1A2-5A2 are coupled with the terminals 1B1-5B1 in terms of signals and a state in which the terminals 1A2-5A2 are coupled with the terminals 1B2-5B2 in terms of signals depending upon the signals inputted to the terminals /BE and BX.

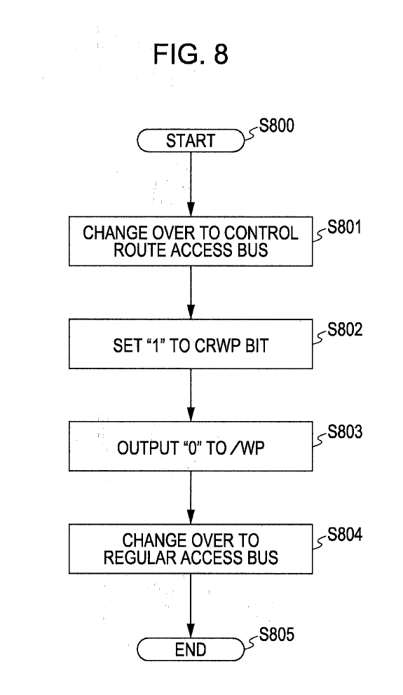

The bus exchange switch 440 switches the connections over among the terminals in terms of signals in accordance with a table 700 illustrated in FIG. 7.

If, e.g., “0” is inputted to the terminals /BE and BX, the bus exchange switch 440 couples the terminals 1A1-5A1 with the terminals 1B1-5B1 in terms of signals, and couples the terminals 1A2-5A2 with the terminals 1B2-5B2 in terms of signals.

Further, if “0” and “1” are inputted to the terminals /BE and BX, respectively, the bus exchange switch 440 couples the terminals 1A1-5A1 with the terminals 1B2-5B2 in terms of signals, and couples the terminals 1A2-5A2 with the terminals 1B1-5B1 in terms of signals.

The flash memory 450 has terminals D, C, /S, /WP and Q. The terminals D, C, /S and Q are coupled with the terminals 1B1, 2B1, 3B1 and 5B1 of the bus exchange switch 440 in terms of signals, respectively. Further, the terminal /WP is coupled with a signal line FLASH_WP coming from the controller 430 in terms of signals.

Incidentally, the terminals D, C, /S and Q are coupled with the terminals MOSI, SCLK, SS and MISO of the SPI slave 451 in terms of signals, respectively, which is omitted to be illustrated in FIG. 6 though so that coupling relations in terms of signals among the main portions may be understood first.

Further, the flash memory 450 has a controller 453, a shift register 454, a data buffer 455, an address register 456, decoders 457 and 458 and a memory 459 in addition to the SPI slave 451 and the control memory 452.

The controller 453 carries out data communication with another device, e.g., the CPU 420 or the controller 430 by using the SPI slave 451. Then, the controller 453 writes received data into the memory 459 and reads data from the memory 459. The controller 453 writes and reads data into and from the control memory 452, as well.

If an input signal to the terminal /WP indicates “0” and the CRWP bit of the control memory 452 indicates “1”, the controller 453 write-protects data in the control memory 452.

The shift register 454 converts serial data into parallel data of a specific bit length, and vice versa. Serial data inputted by the SPI slave 451, e.g., is converted into parallel data of the specific bit length by the shift register 454.

The data buffer 455 is a storage device in which data to be written into or read from the memory 459 is temporarily stored.

The address register 456 is a storage device in which address data indicating an address of data to be written into or read from the memory 459 is temporarily stored.

The decoder 457 decodes the address data stored in the address register 456 so as to extract, e.g., an upper address. Further, the decoder 458 decodes the address data stored in the address register 456 so as to extract, e.g., a lower address. An address of data on the memory 459 may be chosen according to the upper and lower addresses.

The memory 459 is a non-volatile memory. Upon receiving data from the SPI slave 451 in the above constitution, the controller 453 converts the received data into data of a specific bit length by means of the shift register 454. If the data having been converted includes instructions to write data into the control memory 452, the controller 453 refers to the terminal /WP and the CRWP bit of the control memory 452. If the terminal /WP indicates “0” and the CRWP bit of the control memory 452 indicates “1”, the controller 453 suppresses data processing for writing data into the control memory 452.

Further, if the terminal /WP indicates “1” or the CRWP bit of the control memory 452 indicates “0”, the controller 453 writes the converted data into the control memory 452. The controller 453 may change a particular bit of the control memory 452 in this case.

Further, if the data having been converted by the shift register 454 includes instructions to read data from the control memory 452, the controller 453 converts the data stored in the control memory 452 into serial data by means of the shift register 454. Then, the controller 453 outputs the data in the control memory 452 through the SPI slave 451.

Further, if the data having been converted by the shift register 454 includes instructions to write data into the memory 459, the controller 453 refers to the write-protection bit of the control memory 452. If the write-protection bit indicates “1”, the controller 453 suppresses data processing for writing data into the memory 459.

Further, if the write-protection bit of the control memory 452 indicates “0”, the controller 453 files address data included in the converted data in the address register 456. Further, the controller 453 files a data portion included in the converted data in the data buffer 455. Then, the controller 453 stores the data filed in the data buffer 455 into an address identified by the upper and lower addresses decoded by the decoders 457 and 458.

Further, if the data converted by the shift register 454 includes instructions to read data from the memory 459, the controller 453 files the address data included in the converted data in the address register 456. Then, the controller 453 files the data filed to the address identified by the upper and lower addresses decoded by the decoders 457 and 458 in the data buffer 455. The controller 453 converts the data filed in the data buffer 455 into serial data by means of the shift register 454. Then, the controller 453 outputs the data through the SPI slave 451.

A communication line which couples the CPU 420 with the flash memory 450 in terms of signals used for communication using the SPI is called a “regular access bus” hereafter. Further, a communication line which couples the controller 430 with the flash memory 450 in terms of signals used for communication using the SPI is called a “control route access bus”. Then, signal lines including signal lines coupled with the terminals /BE and BX in terms of signals and a signal line coupled with the terminal /WP of the flash memory 450 in terms of signals both being included in the communication line coupling the controller 430 with the flash memory 450 in terms of signals is called a “control route signal bus”.

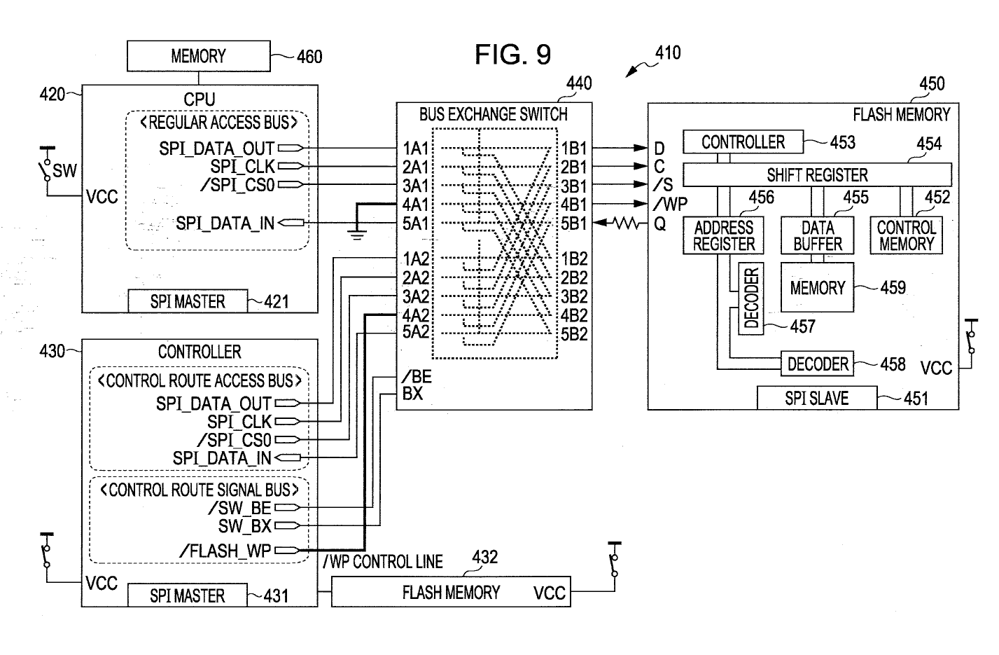

FIG. 8 illustrates an exemplary method for data processing used by the controller 430 of the embodiment. If the data processing device 400 is powered on with the main power source, the controller 430 starts data processing as instructed by a program having been read from the flash memory 432, as follows (operation S800).

The controller 430 changes over to the control route access bus as an operation S801. In this case, the controller 430 outputs “0” to the terminal /BE of the bus exchange switch 440 through the signal line /SW_BE and outputs “1” to the terminal BX of the bus exchange switch 440 through the signal line SW_BX so as to change over to the control route access bus.

The controller 430 uses the control route access bus so as to carry out data communication with the flash memory 450 as an operation S802. Then, the controller 430 instructs the flash memory 450 to set “1” to the CRWP bit of the control memory 452. Then, the flash memory 450 writes “1” into the CRWP bit of the control memory 452 as instructed above.

The controller 430 outputs “0” to the terminal /WP of the flash memory 450 through the signal line /FLASH_WP of the control route signal bus as an operation S803. Incidentally, a signal provided through a signal line of the control route signal bus keeps its value as long as the main power source is supplied.

If the processes of the operations S802 and S803 are completed, write-protection for the control memory 452 of the flash memory 450 is made effective.

The controller 430 changes over from the control route access bus to the regular access bus as an operation S804. In this case, the controller 430 outputs “0” to the terminal /BE of the bus exchange switch 440 through the signal line /SW_BE and outputs “0” to the terminal BX of the bus exchange switch 440 through the signal line SW_BX so as to change over to the regular access bus.

If the above process is completed, the CPU 420 is enabled to read data from the flash memory 450. At the same time, a change in the control memory 452 of the flash memory 450 caused by the CPU 420 is suppressed. If, e.g., “1” is set to the write-protection bit of the control memory 452 as well in the operation 5802, the flash memory 450 may be set in such a state that the CPU 420 may only read data from the flash memory 450.

If the CPU 420 is powered on with the system power source and starts to work after the above process is completed, the operation to power on the system power source and so forth may possibly cause noise in the CPU 420, etc. in some cases. As being coupled in terms of signals not with the CPU 420 but with the controller 430, though, the terminal /WP of the flash memory 450 is not affected by the noise caused in the CPU 420, etc.

As a result, even if noise is caused in the CPU 420 and so forth while the CPU 420 is being coupled with the flash memory 450 in terms of signals through the regular access bus, occurrence of a situation where data in the control memory 452 or the memory 459 is unintentionally rewritten is suppressed.

The controller 430 may control the write-protection state in the flash memory 450 without being affected by the noise caused in the CPU 420, etc. as described above. The write-protection may include the write-protection for the CRWP bit of the flash memory 450 and the write-protection for the memory 459 of the flash memory 450.

### Modification of Embodiments

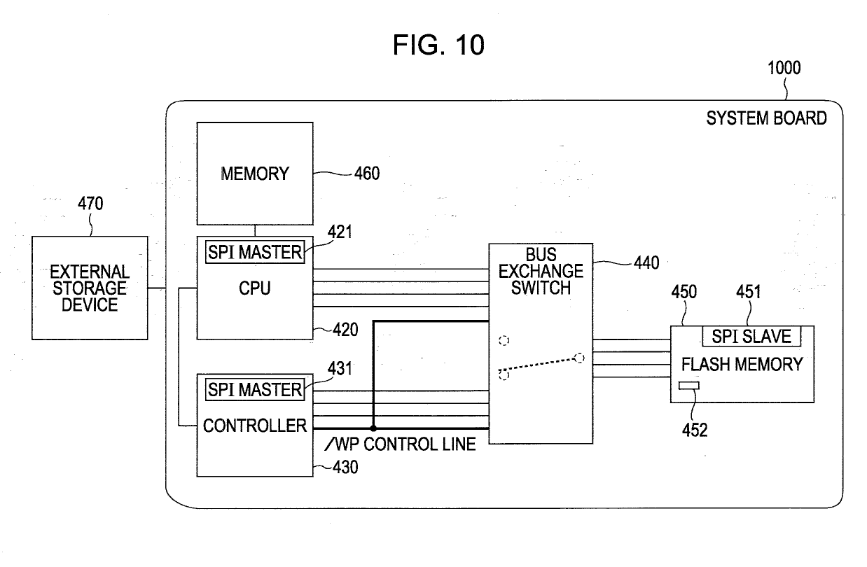

FIG. 9 illustrates a modification of the system board 410 illustrated in FIG. 6.

The controller 430 is coupled with the terminal 4A2 of the bus exchange switch 440 in terms of signals through the signal line /FLASH_WP.

As being grounded, the terminal 4A1 of the bus exchange switch 440 is provided “0” all the time. Further/the terminal 4B1 of the bus exchange switch 440 is coupled with the terminal /WP of the flash memory 450 in terms of signals.

If, e.g., the controller 430 outputs “0” to the terminals /BE and BX of the bus exchange switch 440 in the above constitution, the bus exchange switch 440 couples the terminals 1A1-5A1 and the terminals, 1B1-5B1 in terms of signals. The CPU 420 is coupled with the flash memory 450 in terms of signals through the regular access bus in this case.

As the terminal 4A1 of the bus exchange switch 440 is grounded, though, the terminal 4B1 coupled with the terminal 4A1 in terms of signals outputs “0” to the terminal /WP of the flash memory 450 all the time.

If the CPU 420 is powered on with the system power source and starts to work in the above protection condition, the operation to power on the system power source and so forth may possibly cause noise in the CPU 420, etc in some cases. As not being coupled in terms of signals with the CPU 420 but being grounded, though, the terminal /WP of the flash memory 450 is not affected by the noise caused in the CPU 420, etc.

As a result, even if noise is caused in the CPU 420 and so forth while the CPU 420 is being coupled with the flash memory 450 in terms of signals through the regular access bus, occurrence of a situation where data in the control memory 452 or the memory 459 is unintentionally rewritten is suppressed.

The controller 430 may thereby achieve write-protection for the flash memory 450 without being affected by the noise caused in the CPU 420, etc.

### Another Modification

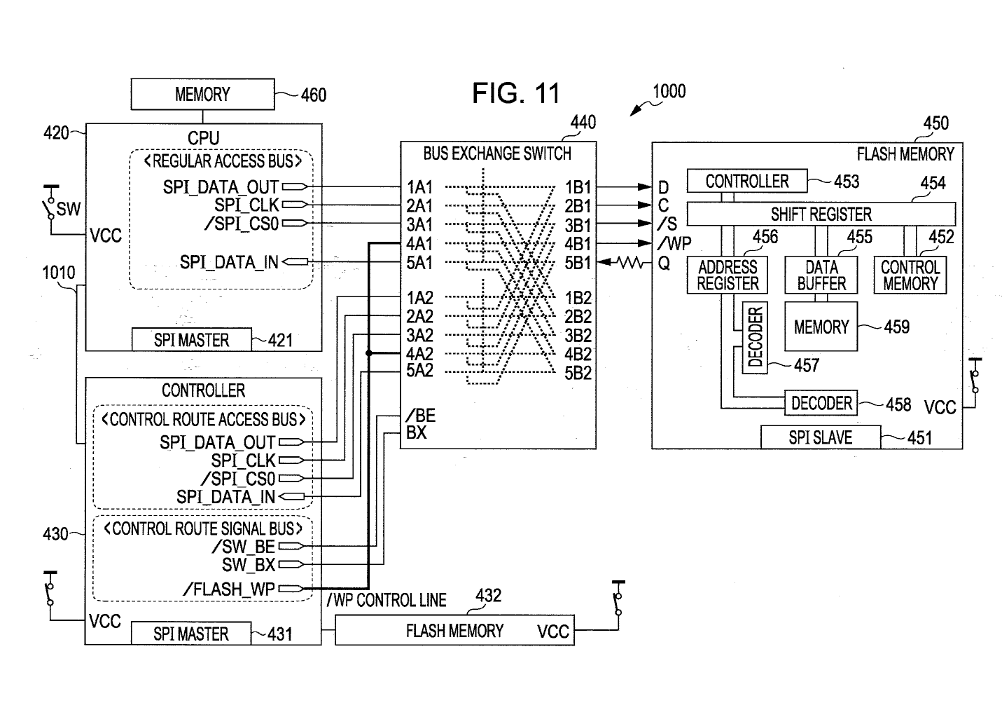

FIG. 10 illustrates a modification of the system board 410 illustrated in FIG. 4.

FIG. 10 illustrates a system board 1000 including the CPU 420 and the controller 430 communicably coupled with each other through an exclusively used line, etc. Explanations of other portions having been explained with reference to FIG. 4 are omitted.

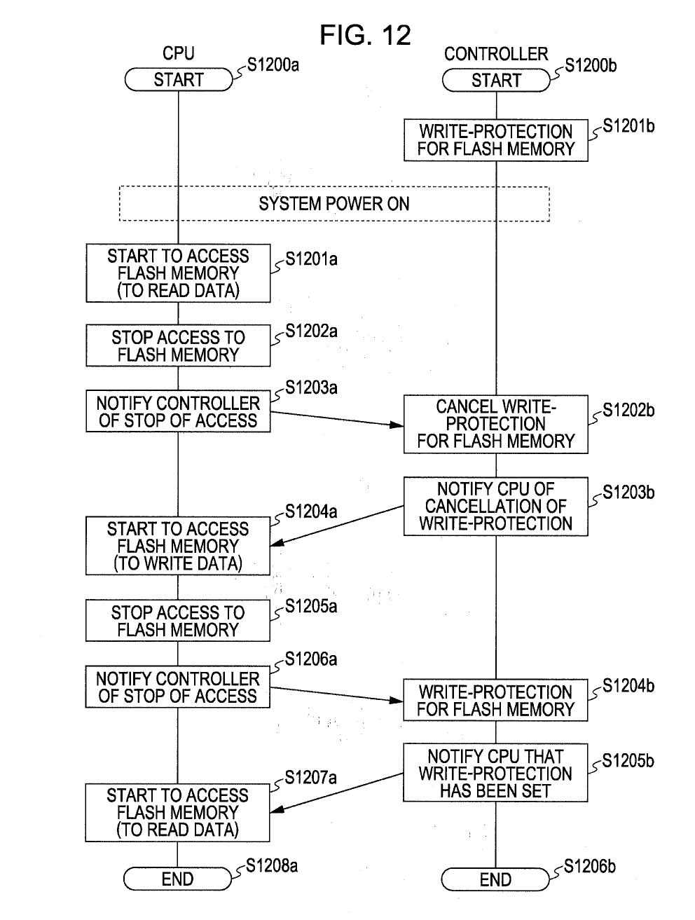

FIG. 11 specifically illustrates an exemplary main portion of the system board 1000 illustrated in FIG. 10.

The CPU 420 and the controller 430 are coupled with each other in terms of signals through an exclusively used communication line 1010. The CPU 420 and the controller 430 communicate with each other through the communication line 1010.

The controller 430 is coupled with the terminals 4A1 and 4A2 of the bus exchange switch 440 in terms of signals through the signal line /FLASH_WP. Further, the terminal 4B1 of the bus exchange switch 440 is coupled with the terminal /WP of the flash memory 450 in terms of signals.

The signal line /FLASH_WP of the controller 430 is coupled with the terminals 4A1 and 4A2 of the bus exchange switch 440 in terms of signals. Thus, even if the bus exchange switch 440 switches over to the regular access bus or to the control route access bus, the controller 430 is coupled with the terminal /WP of the flash memory 450 in terms of signals through the signal line /FLASH_WP all the time. As a result, a constitution being equivalent to the one illustrated in FIG. 6 in which the controller 430 is directly coupled with the terminal /WP of the flash memory 450 is formed.

As being coupled not with the CPU 420 but with the controller 430 in terms of signals all the time as described above, the terminal /WP of the flash memory 450 is not affected by the noise caused in the CPU 420, etc.

As a result, even if noise is caused in the CPU 420 and so forth while the CPU 420 is being coupled with the flash memory 450 in terms of signals through the regular access bus, occurrence of a situation where data in the control memory 452 or the memory 459 is unintentionally rewritten is suppressed.

The controller 430 may thereby control the write-protection state in the flash memory 450 without being affected by the noise caused in the CPU 420, etc.

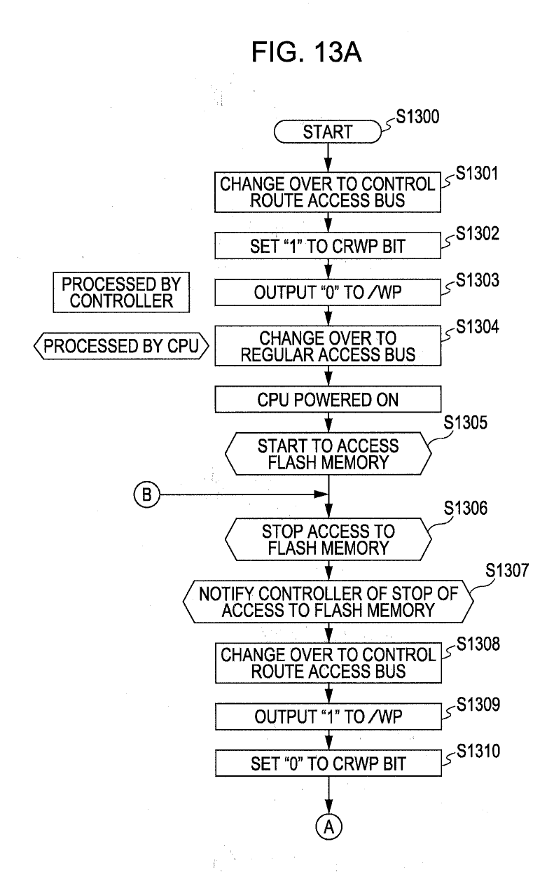

FIG. 12 illustrates an exemplary process run by the system board 1000 illustrated in FIG. 11.

If the data processing device 400 is powered on with the main power source, the controller 430 sets the flash memory 450 into a write-protection state (operation S1201b). Incidentally, the process is similar to that illustrated in FIG. 8 and its detailed explanation is omitted.

If, e.g., a user turns on the system power source, the CPU 420 is supplied with power. Then, the CPU 420 starts to access the flash memory 450 (operation S1201a). The CPU 420, e.g., reads data including the BIOS to be run from the flash memory 450. Then, the CPU 420 does what is instructed by the program including initializing peripherals.

Upon being in need of writing data into the flash memory 450, e.g., the CPU 420 shifts the process to an operation S1202a. Then, the CPU 420 stops accessing the flash memory 450 (operation S1202a).

The CPU 420 notifies the controller 430 through the communication line 1010 of the stop of the access to the flash memory 450 as an operation S1203a. The CPU 420 may include a request for cancellation of the write-protection for the flash memory 450 in the notification.

Meanwhile, upon being notified of the stop of the access to the flash memory 450 by the CPU 420, the controller 430 cancels the write-protection for the flash memory 450 (operation S1202b). Then, the controller 430 notifies the CPU 420 through the communication line 1010 of the cancellation of the write-protection (operation S1203b).

Upon being notified of the cancellation of the write-protection for the flash memory 450, the CPU 420 starts to access the flash memory 450 (operation S1204a). Upon finishing writing specific data into the flash memory 450, the CPU 420 stops accessing the flash memory 450 (operation S1205a). Then, the CPU 420 notifies the controller 430 through the communication line 1010 of the stop of the access to the flash memory 450 (operation S1206a). The CPU 420 may include a request for write-protection to be set for the flash memory 450 in the notification.

Meanwhile, upon being notified of the stop of the access to the flash memory 450 by the CPU 420, the controller 430 sets the write-protection for the flash memory 450 (operation S1204b). Then, the controller 430 notifies the CPU 420 through the communication line 1010 that the write-protection has been set for the flash memory 450 (operation S1205b).

When the controller 430 notified to the CPU 420 that the write-protection has been set for the flash memory 450, the CPU 420 starts to access the flash memory 450 (operation S1207a).

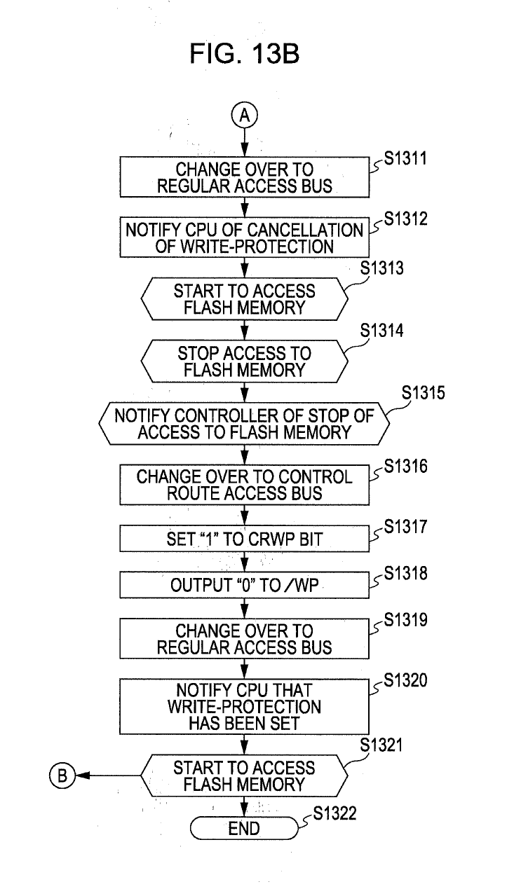

FIGS. 13A and 13B specifically illustrate a method for data processing run by the CPU 420 and the controller 430 as illustrated in FIG. 12.

If the data processing device 400 is powered on with the main power source, the controller 430 runs a process of operations S1301-S1304 as instructed by the program read from the flash memory 450. The process of operations S1301-S1304 corresponds to the process of S1201b illustrated in FIG. 12. Incidentally, the process of operations S1301-S1304 has been explained with reference to FIG. 8 and its repeated explanation is omitted.

If, e.g., a user turns on the system power source, the CPU 420 is supplied with power. Then, the CPU 420 shifts the process to an operation S1305. Then, the CPU 420 starts to access the flash memory 450 (operation S1305). Upon starting to access the flash memory 450, the CPU 420, e.g., reads data including the BIOS to be run from the flash memory 450. Then, the CPU 420 does what is instructed by the program including initializing peripherals.

Upon being in need of writing data into the flash memory 450, e.g., the CPU 420 shifts the process to an operation S1306. In this case, the CPU 420 stops accessing the flash memory 450 (operation S1306). Upon stopping accessing the flash memory 450, the CPU 420 notifies the controller 430 through the communication line 1010 of the stop of the access to the flash memory 450 (operation S1307).

Upon being notified of the stop of the access to the flash memory 450 by the CPU 420, the controller 430 changes the bus from the regular access bus to the control route access bus (operation S1308). The controller 430 outputs “0” to the terminal /BE of the bus exchange switch 440 through the signal line /SW_BE and outputs “1” to the terminal BX of the bus exchange switch 440 through the signal line SW_BX so as to change the bus from the regular access bus to the control route access bus.

Upon changing the bus to the control route access bus, the controller 430 outputs “1” to the terminal /WP of the flash memory 450 through the signal line /FLASH_WP of the control route access bus (operation S1309).

Further, the controller 430 sets “0” to the CRWP bit of the control memory 452 that the flash memory 450 has (operation S1310). To put it specifically, the controller 430 instructs the flash memory 450 to set “0” to the CRWP bit of the control memory 452. Then, the flash memory, 450 runs a process for writing “0” into the CRWP bit of the control memory 452.

Upon finishing the above process, the controller 430 changes the bus from the control route access bus to the regular access bus (operation S1311). The controller 430 outputs “0” to the terminal /BE of the bus exchange switch 440 through the signal line /SW_BE and outputs “0” to the terminal BX of the bus exchange switch 440 through the signal line SW_BX so as to change the bus from the control route access bus to the regular access bus.

The process of operations S1308-S1311 described above corresponds to the process of the operation S1202b illustrated in FIG. 12. The write-protection for the flash memory 450 is cancelled according to the process.

Then, the controller 430 notifies the CPU 420 through the communication line 1010 of the cancellation of the write-protection (operation S1312).

Upon being notified of the cancellation of the write-protection, the CPU 420 starts to access the flash memory 450, i.e., to write data (operation S1313). Upon finishing writing specific data into the flash memory 450, the CPU 420 stops accessing the flash memory 450 (operation S1314).

Then, the CPU 420 notifies the controller 430 through the communication line 1010 of the stop of the access to the flash memory 450 (operation S1315).

Upon being notified of the stop of the access to the flash memory 450 by the CPU 420, the controller 430 changes the bus from the regular access bus to the control route access bus (operation S1316).

Upon changing the bus to the control route access bus, the controller 430 sets “1” to the CRWP bit of the control memory 452 that the flash memory 450 has (operation S1317). Further, the controller 430 outputs “0” to the terminal /WP of the flash memory 450 through the signal line /FLASH_WP of the control route access bus (operation S1318). Upon finishing the above process, the controller 430 changes the bus from the control route access bus to the regular access bus (operation S1319).

The process of the operations S1316-S1319 described above corresponds to the process of the operation S1205b illustrated in FIG. 12. Write-protection is set for the flash memory 450 according to the process.

Then, the controller 430 notifies the CPU 420 through the communication line 1010 that the write-protection has been set (operation S1320).

Upon being notified that the write-protection has been set by the controller 430, the CPU 420 starts to access the flash memory 450, i.e., to read data (operation S1321). Further, upon being in need of writing data into the flash memory 450, the CPU 420 shifts the process to the operation S1306.

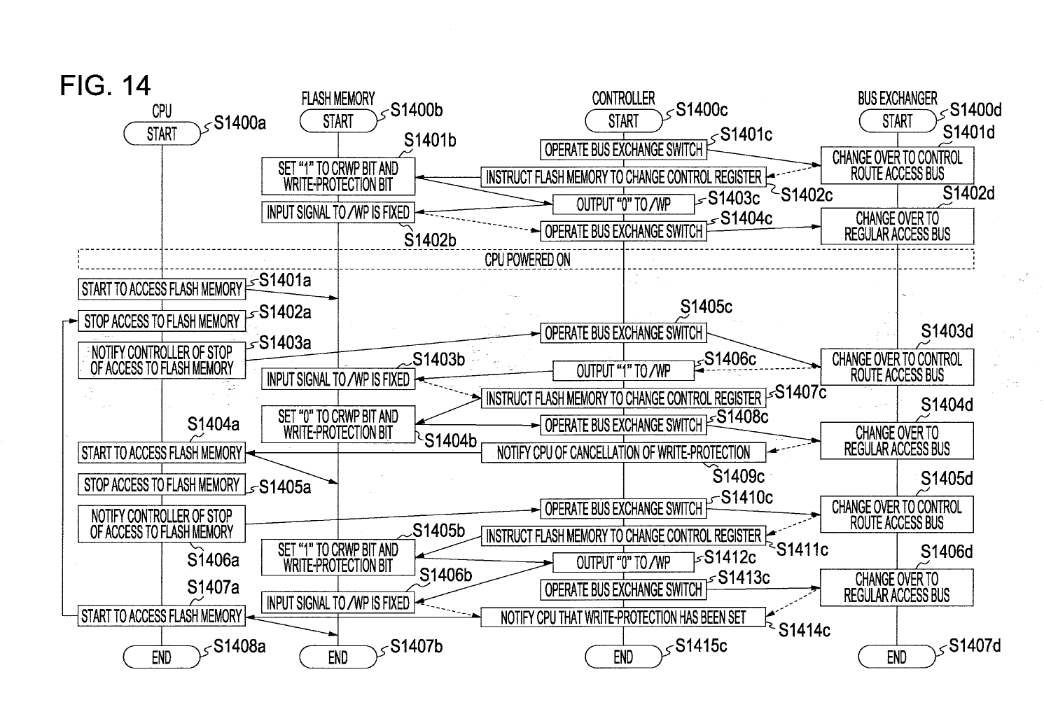

FIG. 14 illustrates a relationship among the devices in the process illustrated in FIGS. 13A and 13B.

If the data processing device 400 is powered on with the main power source, the controller 430 operates the bus exchange switch 440 so as to switch over to the control route access bus (operation S1401c). To put it specifically, the controller 430 outputs “0” to the terminal /BE of the bus exchange switch 440 through the signal line /SW_BE and outputs “1” to the terminal BX of the bus exchange switch 440 through the signal line SW_BX.

Then, the bus exchange switch 440 switches the bus to the control route access bus as operated by the CPU 420 (operation S1401d).

The controller 430 shifts the process to an operation S1402c after a certain period of time since the process of the operation S1401c, in order to secure time enough to complete the bus switchover as restricted by hardware performance and so forth of the bus exchange switch 440, etc.

The controller 430 carries out data communication with the flash memory 450 by using the control route access bus as the operation S1402c. Then, the controller 430 instructs the flash memory 450 to change the control memory 452 (operation S1402c). To put it specifically, the controller 430 instructs the flash memory 450 to set “1” to the CRWP bit of the control memory 452. Further, the controller 430 may instruct the flash memory 450 to set “1” to the write-protection bit of the control memory 452.

Upon being instructed by the controller 430, the flash memory 450 sets “1” to the CRWP bit of the control memory 452 as instructed (operation S1401b). Further, the flash memory 450 sets “1” to the write-protection bit of the control memory 452 as instructed (operation S1401b).

Upon finishing changing the control memory 452, the controller 430 outputs “0” to the terminal /WP of the flash memory 450 through the signal line /FLASH_WP of the control route access bus (operation S1403c). Then, a signal to be inputted to the terminal /WP of the flash memory 450 is fixed (operation S1402b).

The controller 430 shifts the process to an operation S1404c after a certain period of time since the process of the operation S1403c, in order to secure time enough to fix the signal level outputted to the terminal /WP.

The controller 430 operates the bus exchange switch 440 so as to change the bus from the control route access bus to the regular access bus as the operation S1404c (operation S1404c). To put it specifically, the controller 430 outputs “0” to the terminal /BE of the bus exchange switch 440 through the signal line /SW_BE and outputs “0” to the terminal BX of the bus exchange switch 440 through the signal line SW_BX.

Then, the bus exchange switch 440 switches the bus from the control route access bus to the regular access bus as operated by the CPU 420 (operation S1402d).

If the above process is completed, write-protection for the control memory 452 of the flash memory 450 is made effective. Further, if “1” has been set to the write-protection bit as the operation S1401b, write-protection for the memory 459 of the flash memory 450 is made effective, as well.

If, e.g., the user turns on the system power source, the CPU 420 is supplied with power. Then, the CPU 420 shifts the process to the operation S1401a. Then, the CPU 420 starts to access the flash memory 450, i.e., to read data (operation S1401a).

Upon being in need of writing data into the flash memory 450, e.g., the CPU 420 shifts the process to an operation S1402a. In this case, the CPU 420 stops accessing the flash memory 450 (operation S1402a). Upon stopping accessing the flash memory 450, the CPU 420 notifies the controller 430 through the communication line 1010 of the stop of the access to the flash memory 450 (operation S1403a).

Upon being notified of the stop of the access to the flash memory 450 by the CPU 420, the controller 430 operates the bus exchange switch 440 so as to switch the bus from the regular access bus to the control route access bus (operation S1405c). To put it specifically, the controller 430 outputs “0” to the terminal /BE of the bus exchange switch 440 through the signal line /SW_BE and outputs “1” to the terminal BX of the bus exchange switch 440 through the signal line SW_BX.

Then, the bus exchange switch 440 switches the bus from the regular access bus to the control route access bus as operated by the controller 430 (operation S1403d).

Upon changing the bus to the control route access bus, the controller 430 outputs “1” to the terminal /WP of the flash memory 450 through the signal line /FLASH_WP of the control route access bus (operation S1406c). Then, a signal to be inputted to the terminal /WP of the flash memory 450 is fixed (operation S1403b).

Further, the controller 430 uses the control route access bus so as to carry out data communication with the flash memory 450. Then, the controller 430 instructs the flash memory 450 to change the control memory 452 (operation S1407c). To put it specifically, the controller 430 instructs the flash memory 450 to set “0” to the CRWP bit of the control memory 452. Further, the controller 430 may instruct the flash memory 450 to set “0” to the write-protection bit of the control memory 452.

Upon being instructed by the controller 430, the flash memory 450 sets “0” to the CRWP bit of the control memory 452 as instructed (operation S1404b). Further, the flash memory 450 sets “0” to the write-protection bit of the control memory 452 as instructed (operation S1404b).

Upon finishing the above process, the controller 430 operates the bus exchange switch 440 so as to switch the bus from the control route access bus to the regular access bus (operation S1408c). To put it specifically, the controller 430 outputs “0” to the terminal /BE of the bus exchange switch 440 through the signal line /SW_BE and outputs “0” to the terminal BX of the bus exchange switch 440 through the signal line SW_BX.

Then, the bus exchange switch 440 switches the bus from the control route access bus to the regular access bus as operated by the CPU 420 (operation S1404d).

If the above process is completed, the write-protection for the control memory 452 of the flash memory 450 is cancelled. Further, if “0” has been set to the write-protection bit as the operation S1404b, the write-protection for the memory 459 of the flash memory 450 is cancelled, as well.

Then, the controller 430 notifies the CPU 420 through the communication line 1010 of the cancellation of the write-protection (operation S1409c).

Upon being notified of the cancellation of the write-protection by the controller 430, the CPU 420 starts to access the flash memory 450, i.e., to write data (operation S1404a). Upon finishing writing specific data into the flash memory 450, the CPU 420 stops accessing the flash memory 450 (operation S1405a). Then, the CPU 420 notifies the controller 430 through the communication line 1010 of the stop of the access to the flash memory 450 (operation S1406a).

Upon being notified of the stop of the access to the flash memory 450 by the CPU 420, the controller 430 operates the bus exchange switch 440 so as to switch the bus from the regular access bus to the control route access bus (operation S1410c). To put it specifically, the controller 430 outputs “0” to the terminal /BE of the bus exchange switch 440 through the signal line /SW_BE and outputs “1” to the terminal BX of the bus exchange switch 440 through the signal line SW_BX.

Then, the bus exchange switch 440 switches the bus from the regular access bus to the control route access bus as operated by the CPU 420 (operation S1405d).

Upon changing the bus to the control route access bus, the controller 430 carries out data communication with the flash memory 450 by using the control route access bus. Then, the controller 430 instructs the flash memory 450 to change the control memory 452 (operation S1411c). To put it specifically, the controller 430 instructs the flash memory 450 to set “1” to the CRWP bit of the control memory 452. Further, the controller 430 may instruct the flash memory 450 to set “1” to the write-protection bit of the control memory 452.

Upon being instructed by the controller 430, the flash memory 450 sets “1” to the CRWP bit of the control memory 452 as instructed (operation S1405b). Further, the flash memory 450 sets “1” to the write-protection bit of the control memory 452 as instructed (operation S1405b).

Upon finishing changing the control memory 452, the controller 430 outputs “0” to the terminal /WP of the flash memory 450 through the signal line /FLASH_WP of the control route access bus (operation S1412c). Then, a signal to be inputted to the terminal /WP of the flash memory 450 is fixed (operation S1406b).

Upon finishing the above process, the controller 430 operates the bus exchange switch 440 so as to switch the bus from the control route access bus to the regular access bus (operation S1413c). To put it specifically, the controller 430 outputs “0” to the terminal /BE of the bus exchange switch 440 through the signal line /SW_BE and outputs “0” to the terminal BX of the bus exchange switch 440 through the signal line SW_BX.

Then, the bus exchange switch 440 switches the bus from the control route access bus to the regular access bus as operated by the CPU 420 (operation S1406d).

If the above process is completed, the write-protection for the control memory 452 of the flash memory 450 is made effective. Further, if “1” has been set to the write-protection bit as the operation S1405b, the write-protection for the memory 459 of the flash memory 450 is made effective, as well.

Then, the controller 430 notifies the CPU 420 through the communication line 1010 that the write-protection has been set (operation S1414c).

Upon being notified that the write-protection has been set by the controller 430, the CPU 420 starts to access the flash memory 450, i.e., to read data (operation S1407a). Further, upon being in need of writing data into the flash memory 450, the CPU 420 shifts the process to the operation S1402a.

As explained above as to the system board 1000, the CPU 420 instructs the controller 430 through the communication line 1010 so that the CPU 420 may set and cancel the write-protection for the flash memory 450 at the right time.

The controller 430, the flash memory 450, the signal line /FLASH_WP and the CPU 420 explained above are an exemplary control device, an exemplary storage device, an exemplary signal line which couples the control device with the storage device in terms of signals and an exemplary arithmetic operation device, respectively.

The controller 430 includes a processor which runs a specific program so as to implement a first setter, a second setter and an exchange switch. The controller 430 of another embodiment may include one or a plurality of FPGAs (Field-Programmable Gate Arrays) for implementing the first setter, the second setter and the exchange switch. The FPGA of such a constitution may run a process in accordance with logic programmed in advance as an arithmetic operation device. The process of the operation S803 illustrated in FIG. 8, e.g., is an exemplary process run by the first setter. Further, the process of the operation S802 illustrated in FIG. 8, e.g., is an exemplary process run by the second setter. Further, the process of the operation S801 or 5804 illustrated in FIG. 8 is an exemplary process run by the exchange switch.

The control route access bus is an exemplary first transmission line which communicably couples the control device with the storage device in terms of signals. Further, the regular access bus is an exemplary second transmission line which communicably couples the control device with the storage device in terms of signals.

The controller 430 may control the protection condition of the flash memory 450 including settings and cancellation of the write-protection without being affected by the noise caused in the CPU 420 and so forth which is coupled with the flash memory 450 in terms of signals, as described above.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiment of the present invention has been described in detail, it should be understood that the various changes, substitutions, and alterations could be made hereto without departing from the spirit and scope of the invention.

What is claimed is:

1. A control device for controlling a storage device in which data is stored, the control device comprising:
a processor that sets protection condition of the storage device through a signal line coupled with the storage device and sets the protection condition of the storage device through a first transmission line coupled with the control device, and
an exchange switch coupled with the control device and an arithmetic operation device through the first transmission line and a second transmission line, respectively, the exchange switch being configured to switch between the first transmission line and the second transmission line so as to communicably couple either one of the control device and the arithmetic operation device with the storage device.

2. The control device according to claim 1, wherein the signal line is given a particular fixed voltage level independently of the arithmetic operation device upon the exchange switch switching to the second transmission line.

3. The control device according to claim 1, wherein
the control device switches from the second transmission line to the first transmission line upon being instructed by the arithmetic operation device through a communication line which communicably couples the arithmetic operation device with the control device, and switches from the first transmission line to the second transmission line after setting the storage device into particular protection condition according to the instruction.

4. The control device according to claim 1, wherein the processor outputs a particular signal to the storage device through the signal line so as to keep the storage device in particular protection condition.

5. The control device according to claim 1, wherein the processor writes particular data through the first transmission line into a memory which determines protection condition in the storage device so as to set the storage device into particular protection condition.

6. The control device according to claim 1, wherein protection condition in the storage device is determined depending upon settings of the processor.

7. A control device method that controls a storage device, comprising:
setting protection condition of the storage device through a signal line coupled with the storage device and the protection condition of the storage device through a first transmission line coupled with the control device; and
switching between the first transmission line and the second transmission line so as to communicably couple either one of the control device and the arithmetic operation device with the storage device.
